(19) United States
(12) Patent Application Publication
(10) Pub. No.: US 2023/0316559 A1
(43) Pub. Date: Oct. 5, 2023

(54) NETWORK SYSTEM AND INFORMATION PROCESSING METHOD

(71) Applicant: JOHNAN Corporation, Kyoto (JP)

(72) Inventors: Kozo MORIYAMA, Kyoto (JP); Shin KAMEYAMA, Kyoto (JP); Truong Gia VU, Kyoto (JP); Lucas BROOKS, Kyoto (JP)

(21) Appl. No.: 18/188,309

(22) Filed: Mar. 22, 2023

(30) Foreign Application Priority Data
Mar. 29, 2022 (JP) 2022-052959

(51) Int. Cl. G06T 7/70

(52) U.S. Cl. CPC G06T 7/70; G06T 2207/10012; G06T 2207/30204; G06T 2207/10028

(57) ABSTRACT

Provided herein is a network system that includes a wearable terminal having a first camera and a control device capable of communicating with the wearable terminal. The wearable terminal transmits the image captured by the first camera to the control device. The control device calculates a deviation between an optical axis of the first camera and a direction of a user's line-of-sight based on the image captured by the first camera in a state in which a predetermined object is at a predetermined position in the user's field of vision.

### BACKGROUND OF THE INVENTION

### Field of the Invention

The present invention relates to a technology for using a wearable terminal having a camera.

### Description of the Related Art

A wearable terminal having a camera is known. For example, Japanese Patent Laying-Open No. 2012-205163 discloses a wearable camera. It comprises a camera section having an imaging lens and an imaging element. A camera processing unit has a control unit connected to the camera unit and an alarm output unit connected to the control unit. The control unit transmits a dirt detection output to the alarm output unit when dirt is detected on the front part of the imaging lens.

### SUMMARY OF INVENTION

An object of the present invention is to provide a network system capable of recognizing a deviation between a user's line of sight or field of view and an optical axis or field of view of a camera of a wearable terminal.

According to a certain aspect of the present invention, there is provided a network system that includes a wearable terminal having a first camera and a control device capable of communicating with the wearable terminal. The wearable terminal transmits the image captured by the first camera to the control device. The control device calculates a deviation between an optical axis of the first camera and a direction of a user's line-of-sight based on the image captured by the first camera in a state in which a predetermined object is at a predetermined position in the user's field of vision.

The present invention has enabled providing a network system capable of recognizing a deviation between a user's line of sight or field of view and an optical axis or field of view of a camera of a wearable terminal.

### BRIEF DESCRIPTION OF THE DRAWINGS

FIG. 1 is an image diagram showing the overall configuration of a network system according to the first embodiment.

FIGS. 2 is a block diagram of the configuration of the control device according to the first embodiment.

FIG. 3 is a block diagram of a configuration of the wearable terminal according to the first embodiment.

FIG. 4 is a block diagram showing the configuration of the display device according to the first embodiment.

FIG. 5 is a block diagram showing the configuration of the robot according to the first embodiment.

FIG. 6 is a flow chart showing deviation judgment processing according to the first embodiment.

FIG. 7 is a flow chart showing deviation judgment processing according to the second embodiment.

FIG. 8 is an image diagram showing the optical axis and the line of sight direction when viewed from the camera according to the second embodiment.

FIG. 9 is an image diagram showing the optical axis of the camera and the direction of the user's line of sight on a plane spanned by the optical axis of the camera and the direction of the user's line of sight according to the second embodiment.

FIG. 10 a flow chart showing deviation judgment processing according to the third embodiment.

FIG. 11 a flow chart showing deviation judgment processing according to the fourth embodiment.

FIG. 12 a flow chart showing deviation judgment processing according to the fifth embodiment.

FIG. 13 a flow chart showing deviation judgment processing according to the sixth embodiment.

### DESCRIPTION OF THE PREFERRED EMBODIMENTS

Embodiments of the present invention are described below with reference to the accompanying drawings. In the following descriptions, like elements are given like reference numerals. Such like elements will be referred to by the same names, and have the same functions. Accordingly, detailed descriptions of such elements will not be repeated.

### First Embodiment

### Overall Configuration and Brief Overview of Operation of Network System 1

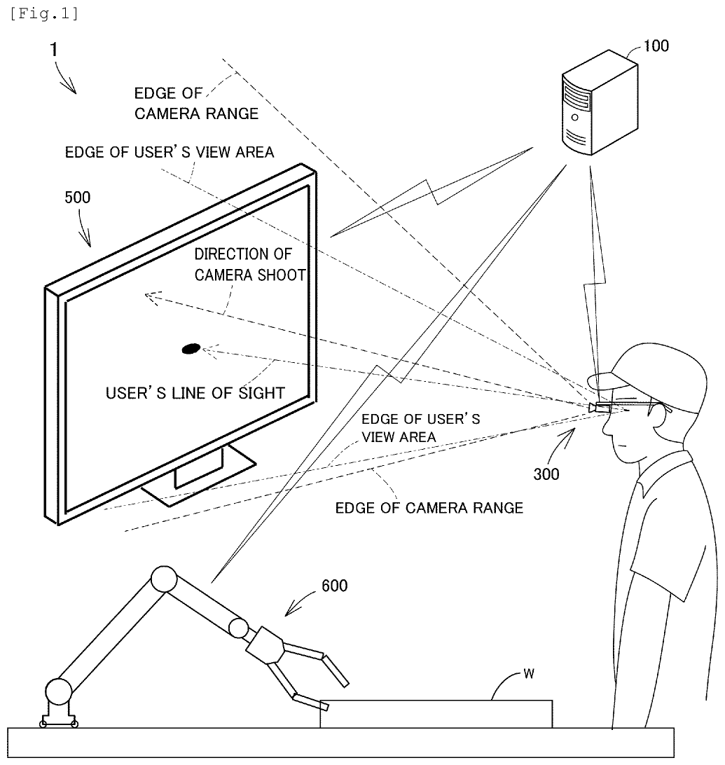

An overall configuration and operation overview of a network system 1 according to an embodiment of the invention is described below, with reference to FIG. 1. Network system 1 according to the present embodiment includes, mainly, a control device 100, a wearable terminal 300, and a display device 500. The network system 1 may include a robot 600 or the like that supports the worker.

The display device 500 is connected to the control device 100, via a wired LAN, wireless LAN, or mobile communication network. The display device 500 displays still images and moving images based on data from the control device 100.

The wearable terminal 300 can be worn on the head of a worker or a user like glasses. The wearable terminal 300 has a camera and transmits a captured image to control device 100.

The robot 600 performs various tasks based on commands from the control device 100 or according to its own judgment.

The control device 100 performs data communication with the wearable terminal 300, the display device 500, and the robot 600, via a wired LAN, wireless LAN, or mobile communication network. In particular, in the present embodiment, the control device 100 instructs the user to look at a predetermined target, acquires a captured still image or movie image from the wearable terminal 300, and calculates the deviation between the direction of the user's line of sight and the optical axis of the camera based on the captured image.

As described above, in this embodiment, it is possible to recognize the deviation between the direction of the user's line of sight and the optical axis of the camera. As a result, it is possible to more accurately identify where the user is looking. The configuration and operation of each part of the network system 1 will be described in detail below.

### Configuration of Control Device 100

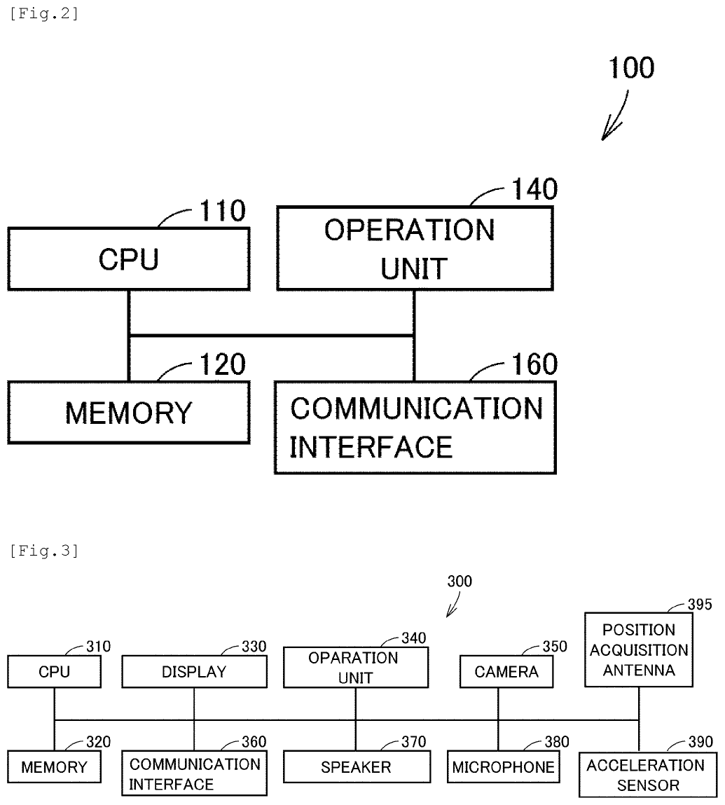

One aspect of the configuration of the control device 100 included in the network system 1 according to the present embodiment will be described. Referring to FIG. 2, control device 100 includes CPU (Central Processing Unit) 110, memory 120, operation unit 140, and communication interface 160 as main components.

CPU 110 controls each part of control device 100 by executing a program stored in memory 120. For example, CPU 110 executes a program stored in memory 120 and refers to various data to perform various processes described later.

Memory 120 is realized by, for example, various types of RAMS (Random Access Memory) and ROMs (Read-Only Memory). The memory 120 may be included in the control device 100 or may be detachable from various interfaces of the control device 100. The memory 120 may be realized by a recording medium of another device accessible from the control device 100. The memory 120 stores programs executed by the CPU 110, data generated by the execution of the programs by the CPU 110, data input from various interfaces, other databases used in this embodiment, and the like.

Operation unit 140 receives commands from users and administrators and inputs the commands to the CPU 110.

Communication interface 160 transmits data from CPU 110 to display device 500, robot 600, and wearable terminal 300 via a wired LAN, wireless LAN, mobile communication network, or the like. Alternatively, communication interface 160 receives data from display device 500, robot 600, or wearable terminal 300 and transfers the data to CPU 110.

### Configuration of Wearable Terminal 300

Next, one aspect of the configuration of the wearable terminal 300 included in the network system 1 will be described. Wearable terminal 300 according to the present embodiment may have the form of glasses, or may be a communication terminal with a camera that can be attached to a hat or clothes.

Referring to FIG. 3, wearable terminal 300 according to the present embodiment includes, as main components, CPU 310, memory 320, display 330, operation unit 340, camera 350, communication antenna 360, speaker 370, microphone 380, an acceleration sensor 390, a position acquisition antenna 395, and the like. The camera 350 of this embodiment is a three-dimensional depth camera. Camera 350 may be a conventional two-dimensional camera.

CPU 310 controls each unit of wearable terminal 300 by executing programs stored in memory 320.

Memory 320 is realized by, for example, various types of RAMS and ROMs. Memory 320 stores various application programs, data generated by execution of programs by CPU 310, data received from control device 100, data input via operation unit 340, image data captured by camera 350, current position data, current acceleration data, current posture data and the like.

Display 330 is held in front of the right eye and/or left eye of the user who is wearing the wearable terminal 300 by various structures. Display 330 displays images and text based on data from CPU 310.

Operation unit 340 includes buttons, switches, and the like. The operation unit 340 inputs various commands input by the user to the CPU 310.

Camera 350 captures still images and moving images based on instructions from CPU 310 and stores image data in memory 320.

Communication antenna 360 transmits and receives data to and from other devices such as control device 100 via a wired LAN, wireless LAN, mobile communication network, or the like. For example, communication antenna 360 receives a capture command from control device 100 and transmits the captured image data in memory 320 to control device 100 according to an instruction from CPU 310.

Speaker 370 outputs various sounds based on signals from CPU 310. CPU 310 may audibly output various voice messages received from control device 100. The CPU 110 also causes the display 330 to output various information.

Microphone 380 receives voice and inputs voice data to CPU 310. The CPU 310 may receive a user's voice message, such as various information and various commands, and pass the voice message data to the control device 100. Note that the CPU 310 also receives information and instructions from the operation unit 340.

The acceleration sensor 390 is, for example, a 6-axis acceleration sensor. The acceleration sensor 390 measures the acceleration and rotation of the wearable terminal 300 and inputs them to the CPU 310. Thereby, the CPU 310 can calculate the posture of the wearable terminal 300.

The position acquisition antenna 395 receives beacons and signals from the outside and inputs them to the CPU 310. Thereby, the CPU 310 can calculate the current position of the wearable terminal 300.

### Configuration of Display Device 500

Next, one aspect of the configuration of the display device 500 included in the network system 1 will be described. Referring to FIG. 4, display device 500 according to the present embodiment includes, as main components, CPU 510, memory 520, screen 530, operation unit 540, camera 550, communication interface 560, speaker 570, and the like.

CPU 510 controls each part of display device 500 by executing programs stored in memory 520.

Memory 520 is implemented by various RAMS, various ROMs, and the like. The memory 520 stores various application programs, data generated by execution of programs by the CPU 510, data input via various interfaces, and the like.

Screen 530 is composed of a plurality of elements, glass, or the like. The screen 530 displays various images, texts, etc. according to instructions from the CPU 510.

Operation unit 540 includes buttons, switches, and the like. The operation unit 540 passes various commands input by the user to the CPU 510. Screen 530 and operation unit 540 may constitute a touch panel.

Camera 550 captures a three-dimensional still image or moving image based on an instruction from CPU 510 and stores the image data in memory 520.

Communication interface 560 transmits and receives data to and from other devices such as control device 100 via a wired LAN, wireless LAN, mobile communication network, or the like. For example, communication interface 560 receives image signals from control device 100 and passes them to CPU 510 and screen 530.

Speaker 570 outputs various sounds based on signals from CPU 510. CPU 510 causes speaker 570 to output various sounds based on its own program or own judgment or instructions from control device 100.

### Configuration of Robot 600

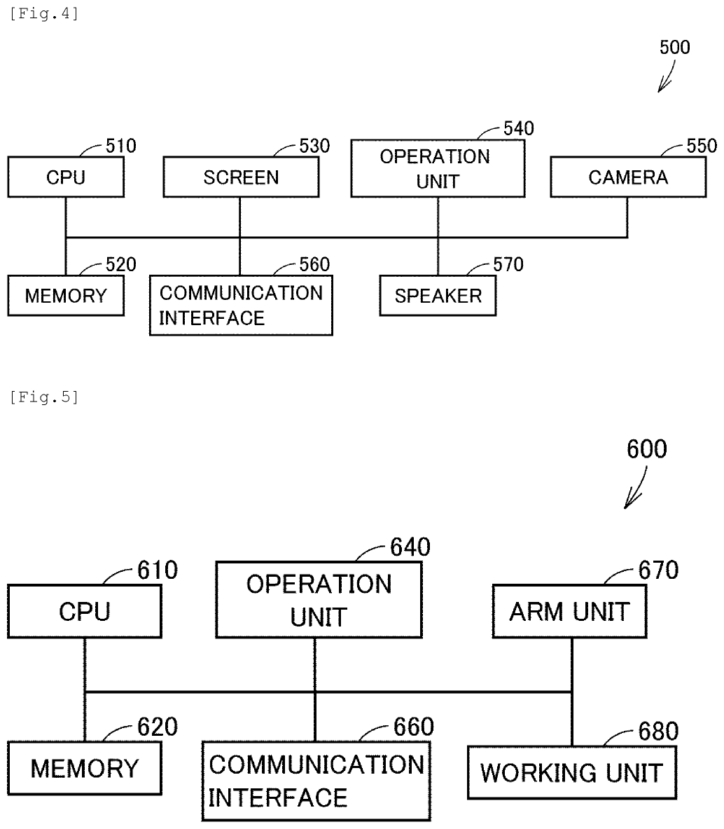

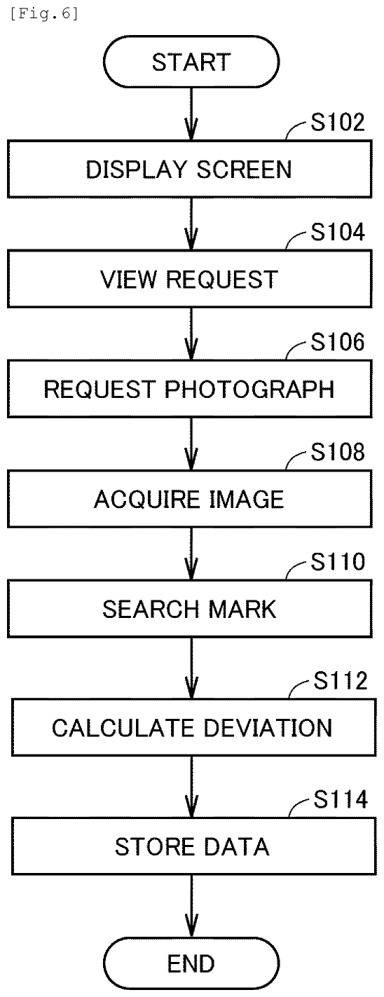

Next, one aspect of the configuration of the robot 600 included in the network system 1 will be described. Referring to FIG. 5, robot 600 according to the present embodiment includes, as main components, CPU 610, memory 620, operation unit 640, communication interface 660, arm unit 670, working unit 680, and the like.

CPU 610 controls each part of the robot 600 by executing various programs stored in the memory 620.

Memory 620 is implemented by various RAMS, various ROMs, and the like. Memory 620 stores various application programs, data generated by execution of programs by CPU 610, operation commands given from control device 100, data input via various interfaces, and the like.

Operation unit 640 includes buttons, switches, and the like. The operation unit 640 transfers various commands input by the user to the CPU 610.

Communication interface 660 transmits and receives data to and from other devices such as control device 100 via a wired LAN, wireless LAN, mobile communication network, or the like. For example, communication interface 660 receives an operation command from control device 100 and passes it to CPU 610.

Arm unit 670 controls the position and orientation of working unit 680 according to instructions from CPU 610.

Working unit 680 performs various operations, such as grasping, releasing an object and using tools, according to instructions from CPU 610.

### Information Processing of Control Device 100

Next, referring to FIG. 1 and FIG. 6, information processing of control device 100 in the present embodiment will be described in detail. CPU 110 of control device 100 executes the processing shown in FIG. 6 according to the program in memory 120.

First, CPU 110 causes display device 500 to display a predetermined screen via communication interface 160 (step S102). An image of a mark for attracting and receiving the user's line of sight is displayed on the screen.

CPU 110 transmits an instruction to wearable terminal 300 via communication interface 160 to output a message instructing the wearable terminal 300 to turn the user's face so that the mark of display device 500 is positioned directly in front of the user's face (step S104). When the CPU 310 of the wearable terminal 300 receives the instruction via the wireless communication antenna 360, the CPU 310 of the wearable terminal 300 causes the speaker 370 to audibly output the message instructing to adjust the orientation of the user's face so that the mark on the display device 500 is positioned in front of the user's face. Alternatively, CPU 310 causes display 330 to display the message.

CPU 110 instructs wearable terminal 300 to photograph the front of wearable terminal 300 via communication interface 160 (step S106).

When CPU 110 acquires a captured image from wearable terminal 300 (step S108), CPU 110 searches for the position of the mark displayed on screen 530 of display device 500 in the captured image (step S110).

The CPU 110 specifies the deviation between the center of the captured image and the position of the mark (step S112). In the present embodiment, the CPU 110 calculates the percentage of deviation in the X-axis direction from the center of the photographed image in the horizontal direction of the photographed image. Similarly, the CPU 110 calculates the percentage of deviation from the center in the Y-axis direction in the vertical direction of the captured image.

CPU 110 stores the calculation result in memory 120 in association with wearable terminal 300 (step S114). As a result, every time the CPU 110 acquires captured images from the wearable terminal 300, the CPU 110 uses the deviation value to specify the direction of the user's line of sight, or roughly estimate the user's field of view.

CPU 110 may cause wearable terminal 300 to audibly output or display a message for correcting the direction of the camera via communication interface 160 when the deviation is large. The message includes “The direction of the camera is not aligned with the direction of your line of sight. Please adjust the direction of the camera to match the direction of your line of sight.” After that, the CPU 110 may execute the process of FIG. 6 again.

### Second Embodiment

In the above embodiment, control device 100 calculates how much the user's line of sight deviates from the center of the camera direction with respect to the horizontal direction and the vertical direction of the photographed image. However, it is not limited to the above form. For example, the three-dimensional depth camera 350 may be used to calculate what direction and how many degrees the user's line of sight deviates from the center of the camera direction.

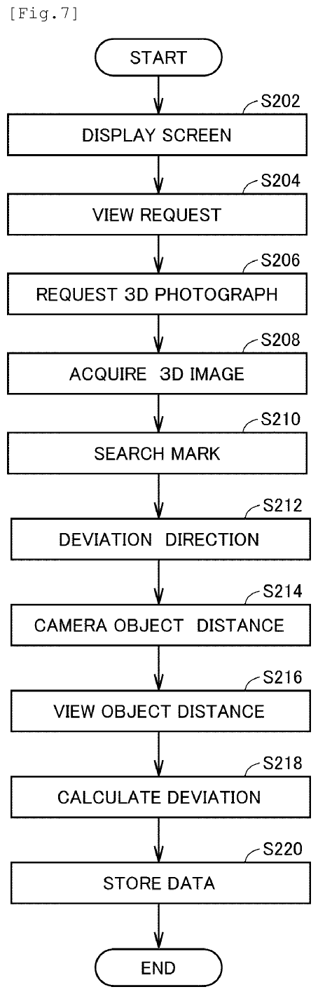

More specifically, referring to FIG. 7, CPU 110 causes display device 500 to display a predetermined screen via communication interface 160 (step S202). An image of a mark for attracting and receiving the user's line of sight is displayed on the screen.

CPU 110 transmits an instruction to wearable terminal 300 via communication interface 160 to output a message instructing that the user's face or line of sight should be directed to the mark on display device 500 (step S204). When CPU 310 of wearable terminal 300 receives the command via wireless communication antenna 360, CPU 310 causes speaker 370 to output a message instructing to turn the front of the user's face to the mark on display device 500. The CPU 310 may cause the display 330 to display the message.

CPU 110 instructs wearable terminal 300 via communication interface 160 to photograph the front with the three-dimensional camera (step S206).

CPU 110 acquires a captured three-dimensional image from wearable terminal 300 (step S208).

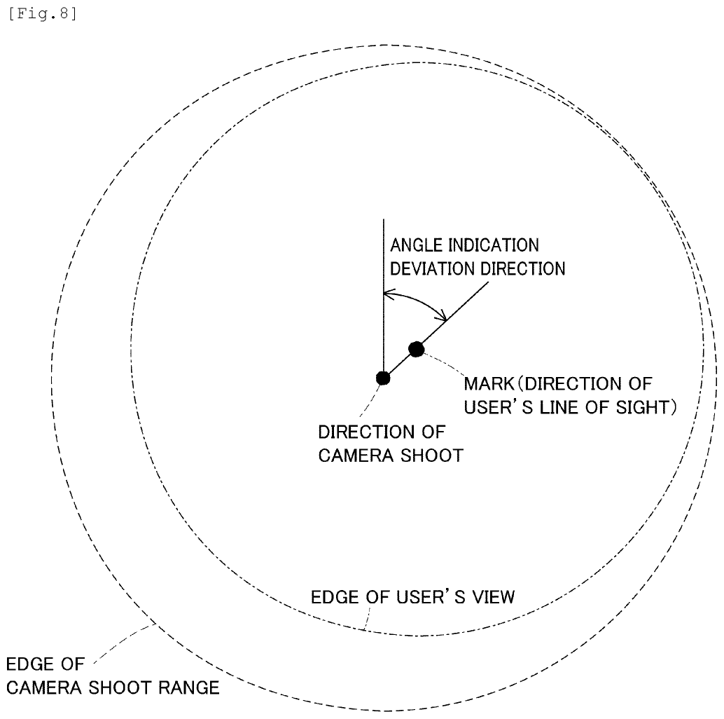

The CPU 110 identifies the position of the mark in the captured three-dimensional image by searching for the mark displayed on the screen 530 of the display device 500 (step S210). Thereby, referring to FIG. 8, CPU 110 identifies the direction in which the direction of the user's line of sight deviates from the center of the captured image (step S212).

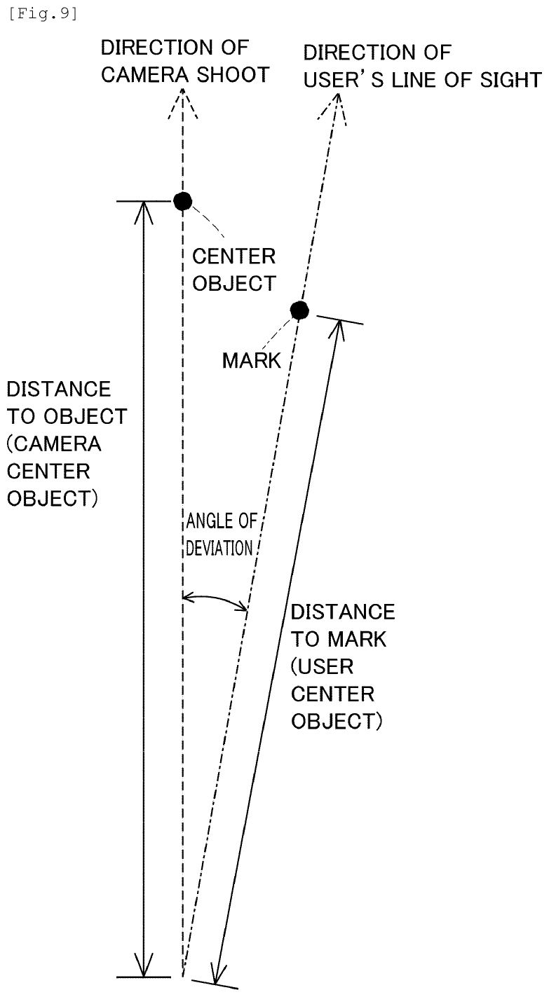

CPU 110 identifies the distance to the object seen in the center based on the captured three-dimensional image (step S214). CPU 110 identifies the distance to the mark based on the captured three-dimensional image (step S216). Accordingly, as shown in FIG. 9, the CPU 110 calculates the angle between the optical axis of the camera 350 and the direction of the user's line of sight (step S218).

The CPU 110 associates a deviation information with the wearable terminal 300. The deviation information includes the direction in which the user's line of sight is deviated from the center of the captured image and the angle between the photographing direction of the camera 350 and the direction of the user's line of sight. CPU 110 stores the deviation information associated the wearable terminal 300 in the memory 120 (step S220). After that, every time the CPU 110 acquires a captured image from the wearable terminal 300, the CPU 110 can identify the direction of the user's line of sight and roughly predict the user's field of view.

When the deviation is large, CPU 110 may cause wearable terminal 300 to audibly output or display a message for correcting the direction of the camera via communication interface 160. The message includes “The camera direction is misaligned with your sight direction. Please adjust the camera direction to match your sight direction.” After that, the CPU 110 may execute the process of FIG. 7 again.

### Third Embodiment

In the above embodiment, the control device 100 identifies the deviation between the imaging direction of the camera 350 and the direction of the user's line of sight. However, it is not limited to the above form. For example, the control device 100 may specify the range of the user's field of view by acquiring the captured image while changing the direction of the user's face or line of sight.

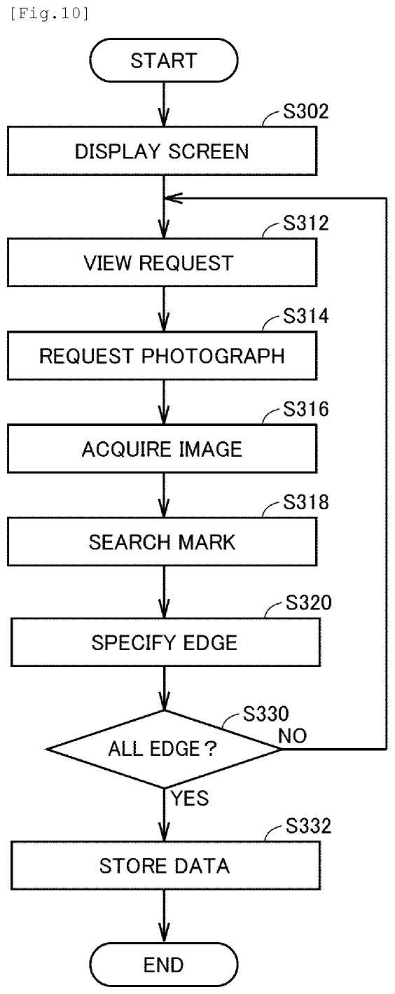

More specifically, referring to FIG. 10, CPU 110 causes display device 500 to display a predetermined screen via communication interface 160 (step 302). An image of a mark for attracting and receiving the user's line of sight is displayed on the screen.

CPU 110 transmits an instruction to wearable terminal 300 via communication interface 160 to output a message “Look at the mark on display device 500 with upturned eyes as much as possible” (step S312). When CPU 310 of wearable terminal 300 receives the command via wireless communication antenna 360, CPU 310 outputs the voice message from speaker 370 or displays the message on display 330.

CPU 110 instructs wearable terminal 300 to photograph the front via communication interface 160 (step S314).

CPU 110 acquires the captured image from wearable terminal 300 via communication interface 160 (step S316).

The CPU 110 identifies the position of the mark in the captured three-dimensional image by searching for the mark displayed on the screen 530 of the display device 500 (step S318).

CPU 110 identifies the position or the direction of the mark with respect to the center position or the center direction of the captured image as the upper end of the user's field of view (step S320).

The CPU 110 also executes the processing from step S312 to step S320 for the lower end, right end, and left end (step S330). That is, CPU 110 identifies the position or the direction of the mark with respect to the center position or the center direction of the captured image as the lower end of the user's field of view, by having the user look at the mark on display device 500 with downturned eyes. Similarly, CPU 110 identifies the position or the direction of the mark with respect to the center position or the center direction of the captured image as the right end of the user's field of view, by having the user look at the mark on display device 500 with rightturned eyes. Similarly, CPU 110 identifies the position or the direction of the mark with respect to the center position or the center direction of the captured image as the left end of the user's field of view, by having the user look at the mark on display device 500 with leftturned eyes.

The CPU 110 stores in the memory 120 information indicating the positions of the top, bottom, right, and left edges of the user's field of view in the captured image (step S332).

After that, every time the CPU 110 acquires a captured image from the wearable terminal 300, the CPU 110 can specify, recognize, or predict the range of the user's field of view.

In the present embodiment, the upper end of the field of vision is specified with the eyes directed upward, and the lower end of the field of vision is specified with the eyes directed downward. The means of determining the field of user's view is not limited to such a form.

More specifically, referring to FIG. 10, CPU 110 causes display device 500 to display a predetermined screen via communication interface 160 (step S302). An image of a mark for attracting and receiving the user's line of sight is displayed on the screen.

CPU 110 transmits an instruction to wearable terminal 300 via communication interface 160 to output a message “Turn your face so that the mark on the display device 500 is at the top of the user's field of vision, with your line of sight facing the front of your face.” (step S312). When CPU 310 of wearable terminal 300 receives the command via wireless communication antenna 360, CPU 310 outputs the voice message from speaker 370 or displays the message on display 330.

CPU 110 instructs wearable terminal 300 to photograph the front via communication interface 160 (step S314).

CPU 110 acquires the captured image from wearable terminal 300 via communication interface 160 (step S316).

The CPU 110 identifies the position of the mark in the captured image by searching for the mark displayed on the screen 530 of the display device 500 (step S318).

CPU 110 identifies the position or the direction of the mark with respect to the center position or the center direction of the captured image as the upper end of the user's field of view (step S320).

The CPU 110 also executes the processing from step S312 to step S320 for the lower end, right end, and left end (step S330). That is, CPU 110 identifies the position or the direction of the mark with respect to the center position or the center direction of the captured image as the lower end of the user's field of view, by having the user turn user's face so that the mark on the display device 500 is at the top of the user's field of vision. Similarly, CPU 110 identifies the position or the direction of the mark with respect to the center position or the center direction of the captured image as the right end of the user's field of view, by having the user turn user's face so that the mark on the display device 500 is at the right end of the user's field of vision. Similarly, CPU 110 identifies the position or the direction of the mark with respect to the center position or the center direction of the captured image as the left end of the user's field of view, by having the user turn user's face so that the mark on the display device 500 is at the left end of the user's field of vision.

The CPU 110 stores in the memory 120 information indicating the positions of the top, bottom, right, and left edges of the user's field of view in the captured image (step S332).

After that, every time the CPU 110 acquires a captured image from the wearable terminal 300, the CPU 110 can specify, recognize, or predict the range of the user's field of view.

### Fourth Embodiment

Alternatively, the control device 100 may acquire the direction and position of the user's face by another method, acquire the camera direction based on the captured image, and calculate the difference between the two. Here, control device 100 acquires the orientation of the user's face by using camera 550 of display device 500.

In this embodiment, memory 120 of control device 100 stores in advance the position and orientation of display device 500, the positions and orientations of marks, and the positions and orientations of other devices and components.

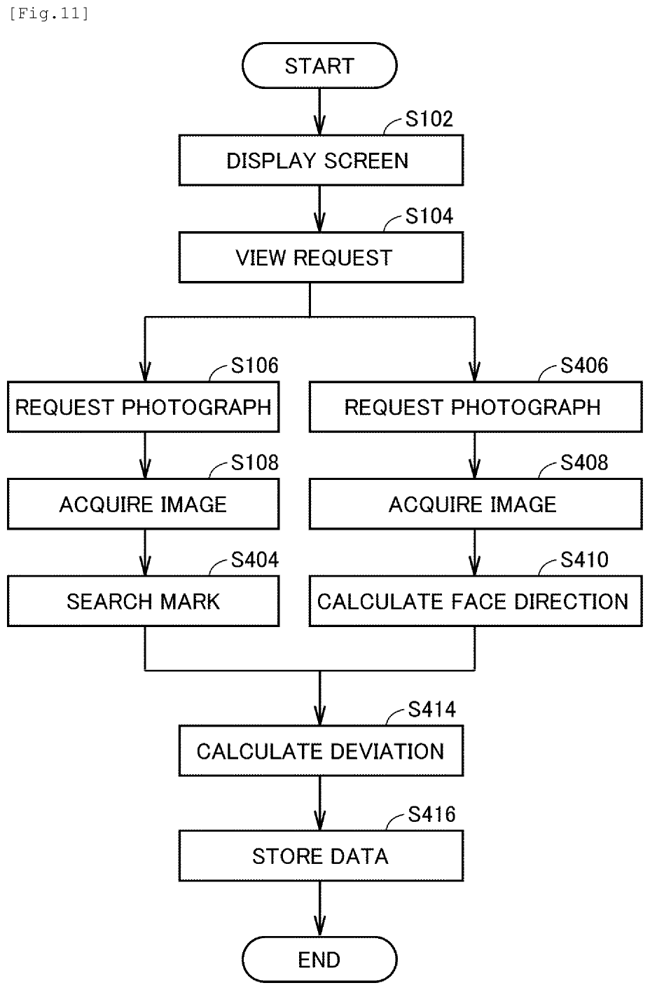

Referring to FIG. 11, CPU 110 causes display device 500 to display a predetermined screen via communication interface 160 (step S102). An image of a mark for attracting and receiving the user's line of sight is displayed on the screen.

CPU 110 transmits an instruction to wearable terminal 300 via communication interface 160 to output a message instructing the wearable terminal 300 to turn the user's face so that the mark of display device 500 is positioned directly in front of the user's face (step S104). When the CPU 310 of the wearable terminal 300 receives the instruction via the wireless communication antenna 360, the CPU 310 of the wearable terminal 300 causes the speaker 370 to audibly output the message instructing to adjust the orientation of the user's face so that the mark on the display device 500 is positioned in front of the user's face. Alternatively, CPU 310 causes display 330 to display the message.

CPU 110 instructs wearable terminal 300 to photograph the front of wearable terminal 300 via communication interface 160 (step S106).

When CPU 110 acquires a captured image from wearable terminal 300 (step S108), CPU 110 identifies the camera direction based on the captured image by using the preset position and orientation of the display device 500, the preset positions and orientations of the marks, and the preset positions and orientations of other devices and components (step S404).

Simultaneously with step S106, CPU 110 instructs display device 500 via communication interface 160 to photograph the front of the display device 500 with the three-dimensional camera (step S406).

When CPU 110 acquires a captured three-dimensional image from display device 500 (step S408), CPU 110 calculates the position and orientation of the user's face based on the captured three-dimensional image (step S410).

CPU 110 calculates the deviation between the photographing direction and the face orientation (step S414).

CPU 110 stores the calculation result in memory 120 in association with wearable terminal 300 (step S416). After that, every time the CPU 110 acquires a captured image from the wearable terminal 300, the CPU 110 can identify the direction of the user's line of sight and roughly predict the user's field of view.

When the deviation is large, CPU 110 may cause wearable terminal 300 to audibly output or display a message for correcting the direction of the camera via communication interface 160. The message includes “The camera direction is misaligned with your sight direction. Please adjust the camera direction to match your sight direction.” After that, the CPU 110 may execute the process of FIG. 11 again.

Further, as described above, the control device 100 may cause the user to look up with upturned eyes, to look down with downturned eyes, to look right with rightturned eyes, and to look left with leftturned eyes. Control device 100 may identify the camera direction and face orientation in each of these states. The control device 100 may specify the direction and magnitude of the average deviation.

### Fifth Embodiment

Alternatively, the control device 100 may acquire the position and orientation of the wearable terminal 300 by another method and determine the camera direction based on the captured image.

In the present embodiment, wearable terminal 300 can acquire its own posture and position by using a 6-axis acceleration sensor, GPS, or the like.

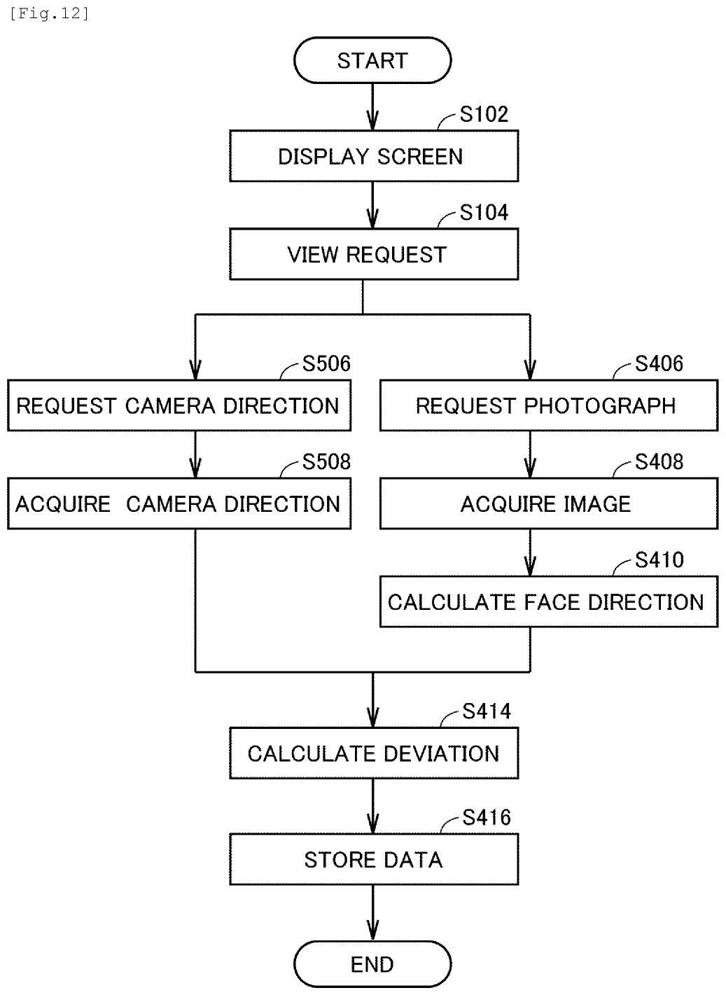

Referring to FIG. 12, CPU 110 causes display device 500 to display a predetermined screen via communication interface 160 (step S102). An image of a mark for attracting and receiving the user's line of sight is displayed on the screen.

CPU 110 requests wearable terminal 300 for its posture, that is, the camera direction, via communication interface 160 (Step S506). When the CPU 310 of the wearable terminal 300 receives the command via the wireless communication antenna 360, the CPU 310 specifies its own posture and camera direction by using the 6-axis acceleration sensor 390, the position acquisition antenna 395, and the like.

CPU 110 acquires the shooting direction from wearable terminal 300 (step S508).

CPU 110 instructs display device 500 via communication interface 160 to photograph the front with the three-dimensional camera (step S406).

When CPU 110 acquires a captured three-dimensional image from display device 500 (step S408), CPU 110 calculates the position and orientation of the user's face based on the captured three-dimensional image (step S410).

CPU 110 calculates the deviation between the shooting direction and the face orientation (step S414).

CPU 110 stores the calculation result in memory 120 in association with wearable terminal 300 (step S416). After that, every time the CPU 110 acquires a captured image from the wearable terminal 300, the CPU 110 can identify the direction of the user's line of sight and predict the rough field of view of the user.

When the deviation is large, CPU 110 may cause wearable terminal 300 to audibly output or display a message for correcting the direction of the camera via communication interface 160. The message includes “The camera shoot direction diverges from your sight direction. Please adjust the camera direction to match your sight direction.” After that, the CPU 110 may execute the process of FIG. 12 again.

Further, as described above, the control device 100 may cause the user to look up with upturned eyes, to look down with downturned eyes, to look right with rightturned eyes, and to look left with leftturned eyes. Control device 100 may identify the shooting direction and face orientation in each of these states. The control device 100 may specify the direction and magnitude of the average deviation.

### Sixth Embodiment

In the third embodiment, the control device 100 specifies the range of the user's field of view by acquiring captured images while changing the direction of the user's face and line of sight. Instead of asking the user to change the direction of the face or line of sight, the mark may be placed on a movable device such as a robot. The control device 100 may specify the positions of the upper end, the lower end, the right end, and the left end of the user's field of view by moving the mark using a robot or the like while the user is stationary.

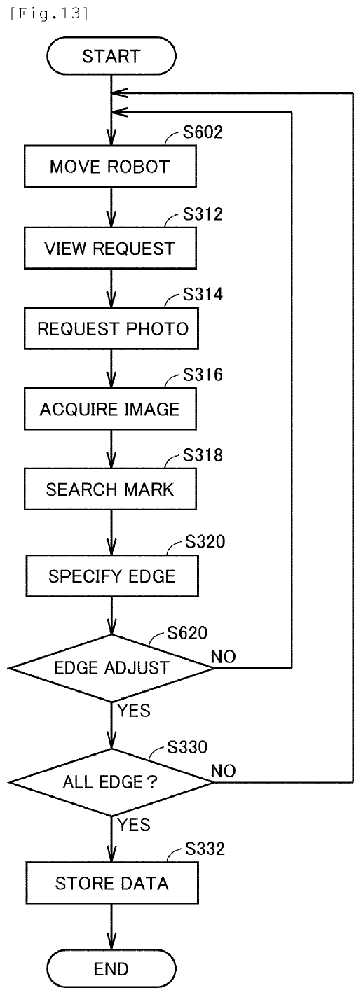

More specifically, referring to FIG. 13, CPU 110 moves a predetermined mark attached to the tip of the robot arm of robot 600 by moving the robot arm via communication interface 160 (step S602).

CPU 110 instructs wearable terminal 300 to photograph the front via communication interface 160 (step S314).

CPU 110 acquires the captured image from wearable terminal 300 (step S316).

The CPU 110 identifies the position of the mark in the captured image by searching for the mark displayed on the screen 530 of the display device 500 (step S318).

The CPU 110 adjusts the posture of the robot 600 so that the mark in the captured image can be recognized at the upper end of the user's field of view (step S602). The CPU 110 repeatedly executes steps S312 to S318 (step S620).

The CPU 110 also executes the processing from step S602 to step S620 for the lower end, right end, and left end (step S330).

The CPU 110 stores in the memory 120 information indicating the positions of the top edge, bottom edge, right edge, and left edge of the user's field of view in the captured image (step S332).

### Seventh Embodiment

Other devices may perform part or all of the role of each device such as the control device 100, the wearable terminal 300, the display device 500, and the robot 600 of the network system 1 of the above embodiment. For example, wearable terminal 300 may play a part of the role of control device 100. A plurality of personal computers may play the role of the control device 100. Information processing of the control device 100 may be executed by a plurality of servers on the cloud.

### Review

The foregoing embodiments provide a network system that includes a wearable terminal having a first camera and a control device capable of communicating with the wearable terminal. The wearable terminal transmits the image captured by the first camera to the control device. The control device calculates a deviation between a shooting direction of the first camera and a direction of a user's line-of-sight based on the image captured by the first camera in a state in which a predetermined object is at a predetermined position in the user's field of vision.

Preferably, the first camera is a three-dimensional camera. The control device calculates an angle between the shooting direction of the first camera and the direction of the user's line-of-sight by specifying the direction and distance to the predetermined object from the first camera based on the image captured by the first camera.

Preferably, the network system further includes a second camera for photographing the user. The second camera is a three-dimensional camera. The control device identifies the direction of the user's face based on the image captured by the second camera and calculates the deviation between the shooting direction of the first camera and the direction of the user's line-of-sight.

The foregoing embodiments provide an information process method that includes the steps of; a user wearing the wearable terminal visually recognizing an object; the wearable terminal capturing an image with a first camera; a control device identifying the position of the object in the captured image; and the control device calculating the deviation between the photographing direction of the first camera and the user's viewing direction, based on the position of the object in the captured image.

The foregoing embodiments provide a network system that includes a wearable terminal having a first camera and a control device capable of communicating with the wearable terminal. The wearable terminal transmits the images captured by the first camera to the control device. The control device specifies a user's view area with respect to the image captured by the first camera based on the respective images in which a predetermined object is positioned at respective edges of the user's view area.

The foregoing embodiments provide an information process method that includes; a first step of visually recognizing a object at the edge of the user's field of view; a second step of capturing an image with a first camera of the wearable terminal; and after repeating the first step and the second step, the control device specifying the user's visible range with respect to the image captured by the first camera based on the images captured by the first camera.

The foregoing embodiments provide a network system that includes a wearable terminal having a first camera; a control device capable of communicating with the wearable terminal; and a drive device for moving an object. The wearable terminal transmits the images captured by the first camera to the control device. The control device specifies a user's view area with respect to the image captured by the first camera based on positions of the object with respect to images captured by the first camera.

The foregoing embodiments provide an information process method that includes; a first step of moving an object by robot arm; a second step of visually recognizing a predetermined object at the edge of a user's field of view wearing the wearable terminal; and after repeating the first step, the second step, and the third step, the control device specifying the range of the user's field of view with respect to the captured images of the first camera based on the captured images of the first camera.

The embodiments disclosed herein are to be considered in all aspects only as illustrative and not restrictive. The scope of the present invention is to be determined by the scope of the appended claims, not by the foregoing descriptions, and the invention is intended to cover all modifications falling within the equivalent meaning and scope of the claims set forth below.

What is claimed is:

1. A network system comprising:
a wearable terminal having a first camera; and
a control device capable of communicating with the wearable terminal, wherein:
the wearable terminal transmits the image captured by the first camera to the control device, and
the control device calculates a deviation between an optical axis of the first camera and a direction of a user's line-of-sight based on the image captured by the first camera in a state in which a predetermined object is at a predetermined position in the user's field of vision.

2. The network system according to claim 1, wherein:
the first camera is a three-dimensional camera,
the control device calculates an angle between the optical axis of the first camera and the direction of the user's line-of-sight by specifying the direction and distance to the predetermined object from the first camera based on the image captured by the first camera.

3. The network system according to claim 1, further comprising a second camera for photographing the user, wherein:
the second camera is a three-dimensional camera,
the control device identifies the direction of the user's face based on the image captured by the second camera and calculates the deviation between the optical axis of the first camera and the direction of the user's line-of-sight.

4. A network system comprising:
a wearable terminal having a first camera; and
a control device capable of communicating with the wearable terminal, wherein:
the wearable terminal transmits the image captured by the first camera to the control device, and
the control device specifies a user's view area with respect to the image captured by the first camera based on the images respectively in which a predetermined object is positioned at edges of the user's view area.

5. A network system comprising:
a wearable terminal having a first camera;
a control device capable of communicating with the wearable terminal; and
a drive device for moving an object, wherein:
the wearable terminal transmits the image captured by the first camera to the control device, and
the control device specifies a user's view area with respect to the image captured by the first camera based on positions of the object with respect to images captured by the first camera.
